(19) United States
(12) Patent Application Publication
(10) Pub. No.: US 2014/0251524 A1
(43) Pub. Date: Sep. 11, 2014

(54) AUTOMOBILE SURFACE PROTECTOR

(71) Applicant: Ramel Herring, Atlanta, GA (US)

(72) Inventor: Ramel Herring, Atlanta, GA (US)

(21) Appl. No.: 14/201,236

(22) Filed: Mar. 7, 2014

Related U.S. Application Data
(60) Provisional application No. 61/775,276, filed on Mar. 8, 2013.

(51) Int. Cl. B60R 13/02

(52) U.S. Cl. CPC B60R 13/0206
USPC 156/60

(57) ABSTRACT

Implementations of a protector for the interior surfaces of an automobile are provided. In some implementations, the protector may comprise one or more strips. In some implementations, a strip may protect one or more edges of an automobile sun visor, for example, where the sun visor is prone to being grabbed to use or move. In some implementations, one or more strips may be added to the interior roof of the automobile where the sun visor touches the roof in an up position. The strips on the roof may prevent any smudges that may collect on the strips on the sun visor from being transferred to the roof when the sun visor is moved to the up position. In some implementations, a protector of the present disclosure may be adhered to other surfaces of an automobile that are prone to smudges from fingertips.

### CROSS REFERENCE TO RELATED APPLICATION

This application claims the benefit of U.S. Patent Application Ser. No. 61/775,276, which was filed on Mar. 8, 2013, and is incorporated herein by reference in its entirety.

### TECHNICAL FIELD

This disclosure relates to implementations of an automobile surface protector.

### BACKGROUND

Automobiles have many interior surfaces that can become soiled. For example, automobile sun visors are used to block out sunlight but easily can become soiled. For example, when an automobile driver or passenger desires to use or move the sun visor, the driver or passenger typically uses his/her finger tips to grab the edge of the sun visor closest to the passenger. If the passenger's finger tips are soiled (e.g., with food, make-up, etc.), undesirable smudges may be transferred to the sun visor.

Existing protectors for automobile sun visors cover a large portion of the sun visor. For example, U.S. Patent Appl. Pub. No. 2005/0275240 discloses a sun visor protector that covers all or substantially all of the sun visor.

### BRIEF DESCRIPTION OF THE DRAWINGS

FIG. 1 illustrates an example automobile sun visor having adhered thereto example strips according to an implementation of the present invention.

FIG. 2 illustrates an example headrest having adhered thereto an example protector according to an implementation of the present invention.

### DETAILED DESCRIPTION

Implementations of a protector for the interior surface of an automobile are provided. An interior surface of an automobile can be made of leather or a fabric material in a variety of colors. In some implementations, the protector may comprise one or more strips. In some implementations, the protector may have a rectangular shape. In some implementations, the protector may be any suitable shape.

Implementations of the present invention may protect one or more edges of an automobile sun visor, for example, where the sun visor is prone to being grabbed to use or move. In some implementations, one or more of the strips may extend the entire length of the sun visor's respective edge or only cover a portion of the edge. In some implementations, one or more strips may be placed end-to-end or spaced apart along an edge. Implementations of the present invention may comprise one or more strips of clear, thin film that can adhere to a sun visor.

In some implementations, an additional strip may be added to the interior roof of the automobile where the sun visor touches the roof in an up position. The additional strip may be placed to coincide with the corresponding strip on the sun visor when the sun visor is in an up position. Other strips may be added to the interior roof to coincide with any other strips on the sun visor. The strips on the roof may prevent any smudges that may collect on the strips on the sun visor from being transferred to the roof when the sun visor is moved to the up position.

In some implementations, the strips of the present disclosure may be adhered to other surfaces of an automobile that are prone to smudges from fingertips such as a headrest. In some implementations, the strips of the present disclosure may be adhered to other surfaces of an automobile such as a door handle panel, sun roof panel, etc. or any other surface. In some implementations, one or more strips may be applied to automobile headrests and door handle panels. In some implementations, one or more strips may be applied to other surfaces in cars or elsewhere.

In some implementations, the strips may be any color, tinted, or transparent. In some implementations, the strips may include a top layer that is water resistant. In some implementations, the strips may be a one-sided adhesive coated film. In some implementations, the strips may be an adhesive coated plastic film. In some implementations, the strips may be any material that can adhere to, and can be removed from, the sun visor or other interior surface without causing damage. In some implementations, the strips may be any material that can be cleaned at least a plurality of times. In some implementations, the strips may be any material wherein the strips become seamless or nearly seamless or invisible or nearly invisible when adhered to an interior surface. In some implementations, the strips may have a matte or glossy finish. In some implementations, the strips may be made of polyurethane or polycarbonate.

In some implementations, a solution is provided for use with the strips. For example, the solution may be provided to clean the surface to which the strips are to be attached prior to attachment. In some implementations, the solution may be used to clean the surface of the strips. In some implementations, the solution may be used to activate an adhesive on one side of the strips.

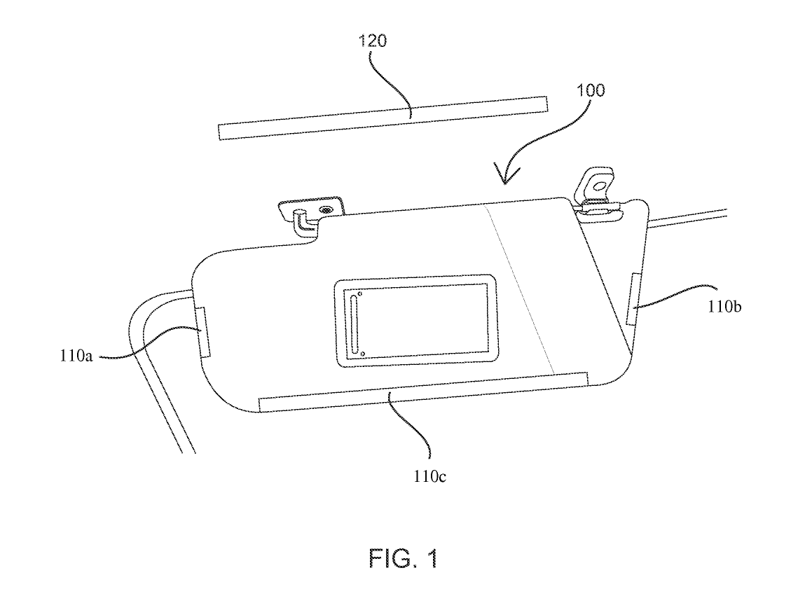

FIG. 1 illustrates an example automobile sun visor 100 having adhered thereto example strips 110a, 110b, 110c according to an implementation of the present invention. As shown in FIG. 1, the strips 110a, 110b, 110c can adhere to one or more edges of the sun visor where it is prone to be grabbed to use or move. In some implementations, one or more of the strips may extend the entire length of the sun visor's respective edge or only cover a portion of the edge. In some implementations, one or more strips may be placed end-to-end or spaced apart along an edge.

In some implementations, an additional strip 120, may be added to the interior roof of the automobile where the sun visor touches the roof in an up position. The additional strip 120 is placed to coincide with the corresponding strip 110c on the sun visor when the sun visor is in an up position. Other strips may be added to the interior roof to coincide with any other strips on the sun visor. The strips on the roof may prevent any smudges that may collect on the strips on the sun visor from being transferred to the roof when the sun visor is moved to the up position.

In some implementations, the strips 110a, 110b, 110c, 120 may be any color, tinted, or transparent. In some implementations, the strips may include a top layer that is water resistant. In some implementations, the strips may be a one-sided adhesive coated film. In some implementations, the strips may be an adhesive coated plastic film. In some implementations, the strips may be any material that can adhere to, and can be removed from, the sun visor or other interior surface without causing damage. In some implementations, the strips may be any material that can be cleaned at least a plurality of times. In some implementations, the strips may be any material wherein the strips become seamless or nearly seamless or invisible or nearly invisible when adhered to an interior surface. In some implementations, the strips may have a matte or glossy finish. In some implementations, the strips may be made of polyurethane or polycarbonate.

In some implementations, a solution is provided for use with the strips. For example, the solution may be provided to clean the surface to which the strips are to be attached prior to attachment. In some implementations, the solution may be used to clean the surface of the strips. In some implementations, the solution may be used to activate an adhesive on one side of the strips.

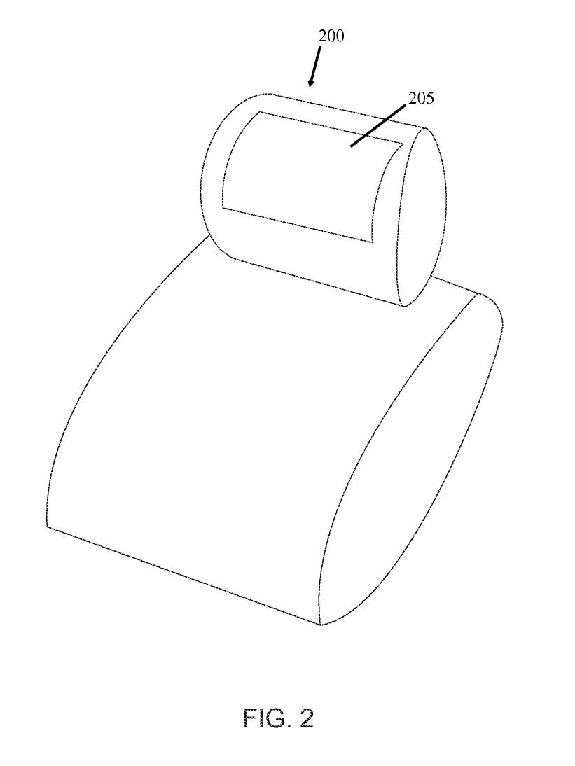

As shown in FIG. 2, the protectors of the present disclosure may be adhered to other surfaces of an automobile that are prone to smudges from fingertips, hair, or other body parts such as a headrest. FIG. 2 illustrates an example automobile headrest 200 having adhered thereto a protector 205.

In some implementations, the protector of the present disclosure may be adhered to other surfaces of an automobile such as a door handle panel, sun roof panel, etc. or any other surface.

To secure a protector to a surface within an automobile, the adhesive portion of a protector may be initially positioned over the portion of the surface to be protected from smudges. The adhesive portion of the protector then is applied to the surface so that it may adhere thereto. In some implementations, the surface is a surface of a sun visor. In some implementations, the surface is a surface on a door handle panel, sun roof panel, etc. or any other surface.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A method of protecting an interior surface of an automobile using an adhesive protector, wherein the adhesive protector comprises a one-sided adhesive coated film, the method comprising:
applying the adhesive protector to an interior surface of an automobile.

2. The method of claim 1, wherein applying the adhesive protector to an interior surface of an automobile comprises applying the adhesive protector on a portion of a sun visor.

3. The method of claim 2, further comprises applying an adhesive protector to a roof location corresponding to the location of the adhesive protector located on the sun visor.

4. The method of claim 1, wherein applying the adhesive protector to an interior surface an automobile comprises applying one of more adhesive protectors to one or more edges of a sun visor.

5. The method of claim 4, further comprises applying one or more adhesive protectors to one or more roof locations corresponding to the location of the one or more adhesive protectors located on the one or more edges of the sun visor.

6. The method of claim 1, wherein applying the adhesive protector to an interior surface of an automobile comprises applying the adhesive protector on a portion of a headrest.

7. The method of claim 1, wherein applying the adhesive protector to an interior surface of an automobile comprises applying the adhesive protector on a portion of a door handle panel.

8. The method of claim 1, further comprising applying a solution to the adhesive protector.

9. The method of claim 1, wherein the adhesive protector is a strip.

10. The method of claim 1, wherein the adhesive protector is shaped like a rectangle.

11. The method of claim 1, wherein the adhesive protector is transparent.

12. The method of claim 1, wherein the adhesive protector is comprised of polyurethane.

13. The method of claim 1, wherein the adhesive protector is comprised of polycarbonate.
